(19) United States
(12) Patent Application Publication
(10) Pub. No.: US 2026/0328275 A1
(43) Pub. Date: Oct. 22, 2026

(54) DRIVE ASSEMBLY AND WORK MACHINE

(71) Applicant: DEERE & COMPANY, MOLINE, IL (US)

(72) Inventors: MATTHIAS LANG, MANNHEIM (DE); RAINER GUGEL, PLANKSTADT (DE); DAVID MUELLER, DETTENHEIM (DE); STEFAN RAISCH, VAIHINGEN AN DER ENZ (DE)

(21) Appl. No.: 19/431,146

(22) Filed: Dec. 23, 2025

(30) Foreign Application Priority Data
Apr. 22, 2025 (EP) 25171553.8
Apr. 22, 2025 (EP) 25171564.5

(51) Int. Cl. F16H 37/06; F16H 63/30

(52) U.S. Cl. CPC F16H 37/065; F16H 63/304

(57) ABSTRACT

The disclosure relates to a drive assembly for a work machine, comprising a transmission device having a first input side, a second input side, a first output side, and a dual-clutch transmission. At least one gear is embodied as a winding path gear, and the dual-clutch transmission is connectable, or connected, to the first output side. and the drive assembly also includes an input shaft, an output shaft, a drive unit, a first energy machine, and a second energy machine. The drive unit is connectable, or connected, to the input shaft. The first energy machine is connectable, or connected, to the input shaft. The second energy machine is connectable to the transmission device. The drive unit is connectable to the first and/or the second input side such that a rotating speed and/or a direction of rotation of the first output side of the transmission device is settable, adjustable, and/or actuable.

### CROSS-REFERENCE TO RELATED APPLICATIONS

This application claims priority to European Patent Application Nos. 25171553.8 and 25171564.5, each filed on Apr. 22, 2025, and which are hereby incorporated by reference.

### TECHNICAL FIELD

The present disclosure relates generally to a drive assembly and a work machine.

### BACKGROUND

For a long time, drive assemblies have been used in work machines, in order to be able to vary the propulsion of the work machine without interruption, even under a high towing load, for example caused by a work implement such as a tilling apparatus (e.g. plough) or the like, attached thereto, beyond simply varying the rotational speed of the drive motor. The drive assembly can in particular be a power-shiftable drive assembly. A known measure is to increase the number of gear ratio stages of a drive assembly by the latter comprising a combination of transmissions, for example by combining a transmission device with a dual-clutch transmission. DE 10 2013 110 709 A1 discloses such a drive assembly. The dual-clutch transmission used therein may in turn be known from WO 2009/050078 A2. A disadvantage of the known drive assemblies is that an excessive amount of installation space is required. In addition, in recent years, work machines have also become established, in particular in the field of agricultural towing vehicles, having drive assemblies which are in the form of continuously variable transmissions. Continuously variable transmissions are conventionally implemented in power-split form with a hydraulically variable path. In order to construct continuously variable transmissions with comfortable shifting operations which are scarcely perceptible, if at all, by the vehicle operator, two variator outputs which are shifted at the synchronization point have to be provided here. This disadvantageously leads to a high degree of complexity in the drive assembly.

Furthermore, it is disadvantageous that the reverse gear in a drive assembly, thus in particular a reversal of the direction of rotation of the drive assembly, occupies a large installation space. At the same time, the achievable and actually achieved speeds should reach approximately the same level in reverse operation as in forward operation (that is to say that at constant engine speed, the occurring speeds before and after the shifting procedure should be approximately the same in terms of absolute value).

### SUMMARY

It is an object of the present disclosure to propose a drive assembly and a work machine that are improved. Specifically, it is an object of the present disclosure to propose a drive assembly and a work machine that in terms of construction are of a simpler and/or more compact design, and/or require less installation space, and/or improve reverse operation.

This object is achieved by a drive assembly having the features of one or more embodiments disclosed herein and by a work machine having the features one or more embodiments disclosed herein.

According to the disclosure, a drive assembly for a work machine is proposed, in particular a continuously variable transmission with an electrical variable path, preferably as a structure coupled at an input side, for a work machine.

The drive assembly comprises
a transmission device having a first and second input side, and a first output side, in particular having a first and second input and a first output,
and a dual-clutch transmission, in particular having more than one stage, wherein at least one gear is in the form of a winding path gear, and the dual-clutch transmission is connectable or connected to the first output side of the transmission device, in particular on the input side,
and an input shaft, wherein in particular the first and/or the second input side can be connectable, or connected, to the input shaft,
and an output shaft,
and a drive unit, wherein the drive unit is connectable, or connected, to the input shaft,
and a first energy machine, the first energy machine being connectable or connected to the input shaft,
and a second energy machine, wherein the second energy machine is connectable, or connected, to the transmission device, connectable, or connected, to a further input side of the transmission device, particularly to a third input side.

The drive unit and/or the first energy machine is connectable, or connected, to the first and/or the second input side, in particular to the first or the second input side, in such a way that in particular a rotating speed and/or a direction of rotation of the first output side of the transmission device is settable and/or adjustable and/or actuable. Specifically, the drive unit and the first energy machine can be connectable, or connected, to the first and/or the second input side, in particular to the first or the second input side, in such a way that in particular a rotating speed and/or a direction of rotation of the first output side of the transmission device is settable and/or adjustable and/or actuable. In other words, a first direction of rotation of the first output side can be implemented by virtue of the fact that the drive unit and/or the first energy machine is to be, or is, connected to the first input side, and a second direction of rotation, in particular a direction counter to the first direction of rotation, can be implemented by virtue of the fact that the drive unit and/or the first energy machine is to be, or is, connected to the second input side. Specifically, the drive assembly can be configured, in particular in such a manner, that the first output side has the first direction of rotation and/or rotates in the first direction of rotation when the drive unit and/or the first energy machine is to be, or is, connected to the first input side, and has a second direction of rotation and/or rotates in the second direction of rotation, in particular in the direction counter to the first direction of rotation, when the drive unit and/or the first energy machine is to be, or is, connected to the second input side. By or due to selecting the connection of the drive unit and/or of the first energy machine to the first or the second input side of the transmission device, a rotating speed and/or a direction of rotation, and/or in particular a rotation, of the first output side of the transmission device can be settable and/or adjustable and/or actuable by the drive assembly, in particular a rotating speed and/or a direction of rotation, and/or in particular rotation, of the first output side counter to the direction of rotation of the drive unit and/or the input shaft can be settable and/or adjustable. As a result, reverse operation of the drive assembly and/or reverse travel of the work machine can be made possible.

Alternatively or in addition, the drive assembly and/or the work machine can comprise a control unit. Alternatively or additionally, the control unit can be configured to connect the drive unit and/or the first energy machine to the first or the second input side in such a way that in particular a rotating speed and/or a direction of rotation of the first output side of the transmission device is settable and/or adjustable and/or actuable. In other words, alternatively or additionally, the control unit can be configured to connect the drive unit and/or the first energy machine to the first input side when the first direction of rotation of the first output side is implemented, and to connect the drive unit and/or the first energy machine to the second input side when the second direction of rotation, which is in particular a direction counter to the first direction of rotation, is implemented. Alternatively or additionally, the control unit can be configured to set and/or adjust and/or actuate the drive assembly, in particular to connect the drive unit and/or the first energy machine to the first input side, in such a way that the first output side has the first direction of rotation and/or rotates in the first direction of rotation and to set and/or adjust and/or actuate the drive assembly, in particular to connect the drive unit and/or the first energy machine to the second input side in such a way that the first output side has the second direction of rotation and/or rotates in the second direction of rotation, in particular in the direction counter to the first direction of rotation. Alternatively or additionally, the control unit can specifically be configured to set and/or adjust and/or actuate a rotating speed and/or a direction of rotation, and/or in particular a rotation, of the first output side of the transmission device by or through the connection of the drive unit and/or the first energy machine to the first or the second input side of the transmission device. As a result, reverse operation of the drive assembly and/or reverse travel of the work machine can be made possible.

“Connected” can be understood as mechanically connected and/or mechanically operatively connected and/or connected for conjoint rotation. Specifically, “connected” can additionally or alternatively be understood as drivably connected, i.e. connected torque-transmittingly and/or so as to transmit rotational speed, and/or coupled, i.e. in particular mechanically coupled and/or rigidly coupled, and/or coupled for conjoint rotation. “Connectable” can be understood as mechanically connectable and/or mechanically operatively connectable and/or connectable for conjoint rotation. Specifically, “connectable” can additionally or alternatively be understood as drivably connectable, i.e. connected torque-transmittingly and/or so as to transmit rotational speed, and/or couplable, i.e. mechanically couplable and/or rigidly couplable, and/or connectable for conjoint rotation. “Connected” can thus specifically be understood to mean a connection between two components, which enables energy and/or force and/or a torque and/or a rotational speed to be transmitted from the one component to the other component, in particular by mechanical means. Further components or parts enabling such a transmission of energy and/or force and/or torque and/or transmission of a rotational speed between the two components can be provided between the two components.

The first and/or second energy machine can be realized in a countershaft design or in an inline design, in particular can be arranged in the drive assembly in a countershaft design or in an inline design. The first and/or second energy machine can be designed as electric motors, in particular as a first and second electric motor. Alternatively or in addition, the first and/or second energy machine can be designed as a fuel cell, in particular as a first and second fuel cell, or can comprise said fuel cell. However, the first and/or the second energy machine can also be a permanent-magnet and/or electrically excited synchronous and/or asynchronous machine that is operated using direct current and/or three-phase current, particularly a permanent-magnet three-phase synchronous machine. The first and the second energy machine can be operable as motors and/or as generators. The first and the second energy machine can drive the drive assembly with a rotational speed and/or a force and/or a torque. The first energy machine, in particular the first electric motor, can comprise a first drive shaft. The second energy machine, in particular the second electric motor, can comprise a second drive shaft. The first and the second energy machine can be operable at each operating point, the one as a motor and the other as a generator. The control unit can be configured to operate the first and the second energy machine at each operating point, the one as a motor and the other as a generator. The control unit can be configured to set and/or adjust and/or control the first and second energy machine at each operating point, in particular in such a way that the one is operated as a motor and the other as a generator.

The first energy machine can be connected on the driven side to the input shaft. For this purpose, a rotor of the first energy machine, in particular an internal rotor, can be connected to the input shaft, for example. The first energy machine can be embodied as a torque motor. In this embodiment, the first energy machine drives directly the input shaft. Likewise, however, the first energy machine can also be connected to the input shaft directly or by way of or with a first or by a first transmission stage, in particular a spur gear stage or a gearwheel pair or a planet set, or a transmission and/or a further shaft. The first energy machine can thus be connected to the input shaft with a fixed transmission ratio or with a variable transmission ratio. The first energy machine can also be designed as a generator and can charge an energy store, in particular in a regeneration mode.

The second energy machine can be connected on the driven side to the second input side of the transmission device. For this purpose, a rotor of the second energy machine, in particular an internal rotor, can be connected to the second input side, for example. The second energy machine can be embodied as a torque motor. Equally, however, the second energy machine can also be connected to the second input side directly or by way of or with a second or by a second transmission stage, in particular a spur gear stage or a gearwheel pair or a planet set, or a transmission and/or a further shaft. The second energy machine can thus be connected to the second input side with a fixed transmission ratio or with a variable transmission ratio, e.g. via the transmission. The second energy machine can also be designed as a generator and can charge the energy store, in particular in a regeneration mode.

The drive assembly, in particular the work machine, can comprise one or more energy stores. The energy store can be electrically connected and/or electrically couplable to the first and/or the second energy machine. The energy store can be an electrical energy store. The energy store can supply the first and/or the second energy machine with energy, in particular electrical energy, and/or power, in particular electrical power. The energy store can be charged, in particular with energy, preferably electrical energy, and/or can be supplied with power, preferably electrical power, by the first and/or the second energy machine in particular when one or both energy machines are operated as generators. The energy store can be designed as a battery and/or a rechargeable battery and/or a supercapacitor and/or a fuel cell and/or any other device for storing electrical energy.

An input side, in particular the first and/or the second and/or the third and/or the fourth input side, can be a mechanical interface by which a force and/or a torque and/or a rotating speed can be introduced into the drive assembly, in particular the transmission device and/or the dual-clutch transmission. An output side, in particular the first and/or the second output side and/or the output shaft, can be a mechanical interface with which a force and/or a torque and/or a rotational speed can be discharged from the drive assembly, in particular from the transmission device and/or the dual-clutch transmission.

The dual-clutch transmission can comprise a first shift element, in particular a first clutch, and a second shift element, in particular a second clutch. The input side or the input sides of the first and/or the second shift element, preferably of the first and the second clutch, can be a fourth input side. The fourth input side of the dual-clutch transmission can be connectable, or connected, in particular directly or indirectly, to the first output side of the transmission device. The first shift element, in particular the first clutch, can be connectable or connected to a first transmission input shaft of the dual-clutch transmission, and the second shift element, in particular the second clutch, can be connectable or connected to a second transmission input shaft of the dual-clutch transmission. The dual-clutch transmission can be mounted in the power flow downstream of the transmission device. Specifically, the first output side can be connectable or connected to the first transmission input shaft via or by the first shift element, and/or to the second transmission input shaft via or by the second shift element. The first and/or the second shift element, in particular the first and/or the second clutch, and/or the first and/or the second transmission input shaft, can be arranged so as to be axially parallel to and/or coaxial with one another.

The first shift element, in particular the first clutch, can be movable and/or shiftable between an open state, in which no rotational speed and/or torque is transmitted to the first transmission input shaft, and a closed state, in which a rotational speed and/or a torque is transmitted to the first transmission input shaft. Specifically, the first shift element, in particular the first clutch, can be movable and/or shiftable between an open state, in which the first output side is released in terms of drive from the first transmission input shaft, and a closed state, in which the first output side is in drive connection with, i.e. is connected to, the first transmission input shaft. The second shift element, in particular the second clutch, can be movable and/or shiftable between an open state, in which no rotational speed and/or torque is transmitted to the second transmission input shaft, and a closed state, in which a rotational speed and/or a torque is transmitted to the second transmission input shaft. Specifically, the second shift element, in particular the second clutch, can be movable and/or shiftable between an open state, in which the first output side is released in terms of drive from the second transmission input shaft, and a closed state, in which the first output side is in drive connection with, i.e. is connected to, the second transmission input shaft.

The first and/or the second transmission input shaft can be connectable or connected to the output shaft, in particular the dual-clutch transmission, via a plurality of cylindrical gear stages of the dual-clutch transmission. In other words, the dual-clutch transmission can comprise one or several spur gear stages, in particular a plurality of spur gear stages. The first and/or the second transmission input shaft can be connectable or connected to the output shaft via the one or more or by the one or more cylindrical gear stages, in particular for setting up gear ratio stages. A spur gear stage can comprise a fixed gear which is co-rotationally arranged on the first or the second transmission input shaft, and a shift gear which is rotatably arranged on the output shaft. Alternatively, a cylindrical gear stage can comprise a fixed gear arranged on the output shaft for conjoint rotation and a shift gear arranged rotatably on the first or the second transmission input shaft.

The first input side can comprise a first drive element or be configured as a first drive element. The second input side can comprise a second drive element or be configured as a second drive element. The third input side can comprise a third drive element or be configured as a third drive element. The first and/or the second and/or the third input side, in particular the first and/or the second and/or the third drive element, can be designed, for example, as a shaft and/or can comprise the latter. The first output side can comprise a first driven element or be configured as a first driven element. The first output side, preferably the first driven element, can, for example, be configured as a shaft and/or can comprise the latter.

The shift elements, in particular the first and/or the second and/or a third and/or a fourth shift element and/or a fifth shift element and/or further shift elements and/or a separating clutch can be connected to the control unit for signalling and/or operatively coupled thereto and/or connected thereto for transmitting signals and/or carrying data. Specifically, each shift element can comprise a valve or a valve assembly, in particular a control valve, or an actuator for controlling and/or setting and/or adjusting the respective assigned shift element. The valve or the valve assembly or the actuator can be connected and/or operatively coupled to the respective assigned shift element. The control unit can be connected to the valve or the valve assembly or to the actuator of the respective assigned shift element for signalling and/or operatively coupled thereto and/or connected thereto for transmitting signals and/or carrying data. The control unit can be configured to control and/or set and/or adjust the shift element, in particular via or with the respective assigned valve or the valve arrangement or the actuator. The control unit can be configured to set and/or adjust the shift element, in particular via the or with the respective assigned valve or the valve assembly or the actuator, to the first position, i.e. the open state, or the second position, i.e. the closed state, in particular also to move same from the first position into the second position, and vice versa.

The shift element, in particular the first and/or the second and/or the third and/or the fourth and/or the fifth shift element and/or further shift elements and/or the separating clutch, can be understood to mean a connecting part by means of which at least one part which transmits energy and/or force and/or a torque and/or a rotating speed is connectable effectively in terms of drive to a further part which transmits energy and/or force and/or a torque and/or a rotating speed or to a part which is fixed in a location or on the housing. The respective shift element is shiftable between at least an open state and a closed state, wherein, in the open state, the shift element cannot transmit either energy and/or force and/or a torque and/or a rotational speed between two parts that interact with the shift element, and wherein, in the closed state, the shift element can transmit energy and/or force and/or a torque and/or a rotational speed between the two parts that interact with the shift element. If there is a connection, in particular an operative connection, between two elements or components of the drive assembly, energy and/or force and/or a torque and/or rotational speed are/is transmitted from one element or one component to the other element or the other component. The shift element, in particular the first and/or the second and/or the third and/or the fourth and/or the fifth shift element and/or further shift elements and/or the separating clutch can be a clutch, in particular a multi-disc clutch, and/or a brake and/or a synchronization mechanism and/or a dog clutch. Specifically, the first and/or the second and/or the third and/or the fourth and/or the fifth shift element and/or further shift elements and/or the separating clutch can be designed as multi-disc clutches (or as dry single-disc clutches), particularly preferably as friction clutches. The first and/or the second and/or the third and/or the fourth and/or the fifth shift element and/or further shift elements and/or the separating clutch can however also be designed as non-powershift clutches.

The drive unit and/or the first energy machine is connected to the input shaft. The drive unit can be designed as an internal combustion engine. Alternatively or additionally, the drive unit can be designed as an electric motor. The first energy machine can be in a constant rotational speed ratio with the drive unit. The second energy machine can be in a constant torque ratio with the drive unit.

It is essential in terms of the disclosure that the drive unit and/or the first energy machine is connectable or connected selectively to the first or the second input side, as a result of which a reversal of the direction of rotation of the first output side of the transmission device can in particular be implemented. The drive assembly can thus be realized as a power-shiftable continuously variable transmission with an electrically variable path. Advantageously, the power to be installed of the first and second energy machines can be reduced. Moreover, the required installation space can be reduced. It is thereby advantageously possible to achieve a construction of the drive assembly that is simple in design and compact. As a result, the drive device, in particular also the work machine, can advantageously be able to be driven in a hybrid manner. Moreover, a battery-electric travel range can advantageously be implemented. By combining the drive unit with the transmission device and the dual clutch transmission, significantly more gears can advantageously be implemented. As a result, the drive assembly has a greater transmission spread. Furthermore, the drive assembly can advantageously be realized as a power-shiftable seamless continuously variable transmission with an electrically variable path, wherein the gear change can take place in the case of rotational speed equality of all the components involved (so-called true seamless shifts).

In a design embodiment of the disclosure, a rotating speed and/or a direction of rotation of the first output side of the transmission device is settable and/or adjustable and/or actuable, preferably a rotating speed and/or a direction of rotation of the first output side of the transmission device is settable and/or adjustable and/or actuable by the second energy machine. In other words, a rotational speed and/or a direction of rotation, and/or in particular a rotation, of the second energy machine can be settable and/or adjustable and/or controllable, in particular in such a way that a rotational speed and/or a direction of rotation, and/or in particular a rotation, of the first output side of the transmission device is settable and/or adjustable and/or controllable. Alternatively or additionally, the control unit can be configured to set and/or adjust and/or actuate a rotating speed and/or a direction of rotation, and/or in particular a rotation, of the first output side of the transmission device by the second energy machine. Specifically, the control unit can be configured to set and/or adjust and/or control a rotational speed and/or a direction of rotation, and/or in particular a rotation, of the second energy machine, in order to set and/or adjust and/or control a rotational speed and/or a direction of rotation, and/or in particular a rotation, of the first output side of the transmission device. Specifically, alternatively or additionally, the control unit can be configured, to set and/or to adjust and/or to actuate the rotating speed and/or direction of rotation, and/or in particular rotation, of the second energy machine and to superimpose the rotating speed and/or direction of rotation, and/or in particular rotation, of the second energy machine in or with the transmission device with the rotating speed and/or direction of rotation, and/or in particular rotation, of the drive unit and/or the input shaft in order to set and/or to adjust and/or to actuate a rotating speed and/or a direction of rotation, and/or in particular a rotation, of the first output side of the transmission device, preferably to set and/or adjust same in the direction counter to the rotating speed and/or direction of rotation, and/or in particular rotation, of the drive unit and/or the input shaft. It is essential that setting and/or adjusting, and/or in particular reversing, the rotating speed and/or direction of rotation, and/or in particular rotation, of the first output side of the transmission device can be implemented by the second energy machine. As a result, the drive assembly can advantageously be implemented as a continuously variable powershift transmission with an electrically variable path.

In a refinement of the disclosure, the transmission device is designed as an epicyclic transmission stage. The transmission device can be designed as a mechanical epicyclic transmission stage, in particular an electrically power-split epicyclic transmission stage. The transmission device, in particular the epicyclic transmission stage, can comprise a planetary transmission, in particular a first planetary transmission, or a reduced planetary transmission, in particular a first reduced planetary transmission, and/or can be embodied as a planetary transmission, in particular the first planetary transmission, or reduced planetary transmission, in particular the first reduced planetary transmission. The planetary transmission, in particular the first planetary transmission, or the reduced planetary transmission, in particular the first reduced planetary transmission, can comprise a positive and a negative planetary stage, preferably can be designed as a combined positive and negative planetary stage.

The transmission device, preferably the epicyclic transmission stage, particularly preferably the planetary transmission, in particular the first planetary transmission, or the reduced planetary transmission, in particular the first reduced planetary transmission, can have a total of four mechanical interfaces, preferably the input and the output sides, particularly the inputs and the outputs. Specifically, the total of four mechanical interfaces, preferably the input and the output sides, particularly preferably the inputs and the outputs, can have four shafts leading to the outside. Specifically, one of the mechanical interfaces, preferably input sides, particularly inputs or in particular one of the shafts, can be connected to the second electric machine.

The first and/or the second input side of the transmission device, preferably of the epicyclic transmission stage, particularly of the planetary transmission, in particular of the first planetary transmission, or of the reduced planetary transmission, in particular of the first reduced planetary transmission, can be connectable or connected, in particular selectively, to the input shaft. The drive unit and/or the first energy machine can be connectable or connected, preferably selectively, to the first and/or the second input side, in particular to the first or the second input side, by way of or through the input shaft, and in particular through a third and/or a fourth shift element, or by a third and/or a fourth shift element.

The third input side of the transmission device, preferably of the epicyclic transmission stage, particularly of the reduced planetary transmission or of the first reduced planetary transmission, can be connectable, or connected, to the second energy machine.

The first output side of the transmission device, preferably of the epicyclic transmission stage, particularly of the reduced planetary transmission or of the first reduced planetary transmission, can be connected to the dual-clutch transmission, preferably to the fourth input side of the dual-clutch transmission, or to an input side of the first and the second shift element. Advantageously, the direction of rotation of the first output side can be set and/or adjusted by the, in particular selective, input-side coupling of the first or second input side of the transmission device, preferably of the epicyclic transmission stage, particularly of the reduced planetary transmission or of the first reduced planetary transmission, to the drive unit and/or to the first energy machine. Specifically, the first output side can have a first direction of rotation and/or rotate in the first direction of rotation, or have the second direction of rotation and/or rotate in the second direction of rotation, in particular in the direction counter to the first direction of rotation. By combining the dual-clutch transmission with the epicyclic transmission stage as part of a variator with a first output side, i.e. only one output, the installation space required can be reduced. It is thereby advantageously possible to achieve a construction of the drive assembly that is simple in design and compact. Otherwise, the drive assembly has the advantages mentioned above.

In a refinement of the disclosure, the dual-clutch transmission comprises the first and second shift element, wherein the first shift element is connected to the first transmission input shaft and the second shift element is connected to the second transmission input shaft. The dual-clutch transmission can comprise one or more cylindrical gear stages each having a fixed gear arranged on the first or second transmission input shaft for conjoint rotation and each having a shift gear arranged rotatably on the output shaft and/or one or more cylindrical gear stages each having a fixed gear arranged on the output shaft for conjoint rotation and each having a shift gear arranged rotatably on the first or second transmission input shaft. The shift gears, for example gearwheels or gear-ratio gearwheels, can be arranged and/or mounted, in particular rotatably arranged and/or rotatably mounted, on the output shaft and/or on the first and/or second transmission input shaft. Fixed gears, for example gearwheels, can be arranged on the first and/or second transmission input shaft and/or on the output shaft, in particular arranged for conjoint rotation, and/or connected to the output shaft. The fixed gears can be in engagement with the shift gears.

The drive assembly, in particular the dual-clutch transmission, can have a plurality of cylindrical gear stages, in particular at least two, four, preferably precisely four, or more cylindrical gear stages, for setting up gear ratio stages, in particular group gear ratio stages. Specifically, a first cylindrical gear stage and a second cylindrical gear stage can each have the fixed gear on the first transmission input shaft and can each have the shift gear on the output shaft. A third cylindrical gear stage and a fourth cylindrical gear stage can each have the fixed gear on the second transmission input shaft and can each have the shift gear on the output shaft. Furthermore, the dual-clutch transmission can comprise one or more coupling elements for coupling two shift gears, wherein in particular the coupling element or the coupling elements can be rotatably mounted on the output shaft, or can be connected to the output shaft not for conjoint rotation. The shift gear of the second cylindrical gear stage and the shift gear of the third cylindrical gear stage can be couplable, preferably selectively couplable, by a first coupling element in such a way that at least one winding path gear ratio stage is able to be formed via the second and the third cylindrical gear stages. In this respect, the shift gear of the second cylindrical gear stage and the shift gear of the third cylindrical gear stage can be couplable in particular in combination with the first or the fourth cylindrical gear stage, that is to say in particular when the first or the fourth cylindrical gear stage is also fixed or coupled by further coupling elements to the output shaft for conjoint rotation. In other words, the shift gear of the second cylindrical gear stage and the shift gear of the third cylindrical gear stage and the first coupling element can be arranged on the output shaft in such a way, and in particular the shift gear of the second cylindrical gear stage and the shift gear of the third cylindrical gear stage can be connectable and releasable by means of the first coupling element in such a way, that at least one winding path gear ratio stage is shiftable via the first coupling element. The power flow of the winding path gear ratio stage here can run over at least three cylindrical gear stages having mutually meshing fixed gears and shift gears. The highest gear ratio stage and the lowest gear ratio stage can be implemented as winding path gear ratio stages. The dual-clutch transmission can preferably comprise six gear ratio stages, particularly six power-shiftable gear ratio stages.

On the driven side, the output shaft can be assigned to the dual-clutch transmission. The dual-clutch transmission can be connected on the input side to the first output side, in particular to the first ring gear or the first planet carrier or a sun, in particular the third sun, of the second planetary transmission, for example via a shaft. The first and/or the second transmission input shaft can be brought into driving connection with the output shaft. The first and/or the second transmission input shaft can be in the form of hollow shafts. The input shaft can be designed as a solid shaft. Moreover, the input shaft and/or the first and/or the second transmission input shaft can be arranged coaxially with one another and/or one in the other, in particular one in the other so as to be able to freely rotate. Specifically, the second transmission input shaft can be arranged and/or mounted in the first transmission input shaft, in particular arranged so as to be able to freely rotate and/or mounted so as to be able to freely rotate. Moreover, the input shaft can be arranged and/or mounted in the second transmission input shaft, in particular arranged so as to be able to freely rotate and/or mounted so as to be able to freely rotate.

The dual-clutch transmission can moreover comprise the first coupling element. The first coupling element can in particular be designed to couple the shift gears of the second and the third cylindrical gear stage. For this purpose, the first coupling element can be arranged on the output shaft between the second and the third cylindrical gear stages, and in particular mounted on the output shaft. The two shift gears can be connectable to the first coupling element for conjoint rotation and so as to be releasable, the two coupled shift gears in particular being able to be rotatably and/or loosely arranged on the output shaft. In this context, the two rotatably mounted shift gears of the second and the third cylindrical gear stages can be couplable via the first coupling element in such a way that a connection between the two shift gears for conjoint rotation is able to be established as a function of a shifting state of the first coupling element. In other words, the two shift gears can be connected to the first coupling element in such a way that the first and the second transmission input shafts are placed in dependence on one another. Specifically, in the case of a winding path gear ratio stage, the shift gear of the second cylindrical gear stage and the shift gear of the third cylindrical gear stage are thus coupled to one another in order to implement a common force flow and power flow through the first and the second transmission input shaft as a result.

Specifically, the dual-clutch transmission can comprise precisely two transmission input shafts, the first and the second transmission input shaft, precisely the output shaft, and precisely the first and the second shift element. Moreover, the dual-clutch transmission can comprise precisely four cylindrical gear stages. The first cylindrical gear stage can comprise a first fixed gear which is arranged in particular at or on the first transmission input shaft and which can engage with a first shift gear which is arranged in particular at or on the output shaft. The second cylindrical gear stage can comprise a second fixed gear which is arranged in particular at or on the first transmission input shaft and which can engage with a second shift gear which is arranged in particular at or on the output shaft. The third cylindrical gear stage can comprise a third fixed gear which is arranged in particular at or on the second transmission input shaft and which can engage with a third shift gear which is arranged in particular at or on the output shaft. The fourth cylindrical gear stage can comprise a fourth fixed gear which is arranged in particular at or on the second transmission input shaft and which can engage with a fourth shift gear which is arranged in particular at or on the output shaft.

If a winding path gear ratio stage is shifted, two of the shift gears, i.e. in particular the second and the third shift gear, can be connected to one another by the first coupling element for conjoint rotation and at the same time the first or the fourth cylindrical gear stage can be activated, i.e. at the same time the first shift gear can be connected to the output shaft by a second coupling element or the fourth shift gear can be connected to the output shaft by a third coupling element. As a result, two gear ratio stages can be realized as winding path gear ratio stages. The dual-clutch transmission can thus specifically comprise six gear ratio stages or group gear ratio stages, which in particular are power-shiftable. The dual-clutch transmission can have four gear ratio stages which are shiftable via one cylindrical gear stage and, in addition, two gear ratio stages which are shiftable as winding path gear ratio stages.

The first coupling element can be movable between a first shift position, in which the shift gear of the second cylindrical gear stage and the shift gear of the third cylindrical gear stage are coupled, and a second shift position, in which the shift gear of the second cylindrical gear stage and the shift gear of the third cylindrical gear stage are released from one another. The shift gears can be connectable by the first and/or second and/or third coupling element to the output shaft for conjoint rotation and so as to be releasable; in particular, in each case one of the shift gears can be connectable by one of the coupling elements to the output shaft for conjoint rotation and so as to be releasable. The coupling elements can be mounted on the output shaft for conjoint rotation and so as to be axially displaceable, and/or can be movable, in particular axially movable, by means of one or more actuating elements. The coupling elements can be arranged between in each case two shift gears, wherein in particular the fixed gears associated with the shift gears are arranged on the same transmission input shaft, i.e. on the first or the second transmission input shaft. The first coupling element can be arranged between the second and the third cylindrical gear stage on or at the output shaft. The second coupling element can be arranged between the first and the second cylindrical gear stage on or at the output shaft. The third coupling element can be arranged between the third and the fourth cylindrical gear stage on or at the output shaft. The first and/or second and/or third coupling element can be designed in a form known per se as dog clutches or as actuating apparatuses, in particular sliding sleeves, and shift assemblies, comprising synchronizing rings, or synchronizers. In any case, the coupling elements are coupling means which are arranged on the output shaft for conjoint rotation and so as to be axially displaceable and by means of which the shift gears are connectable to the output shaft for conjoint rotation for the purpose of activating a transmission ratio. The coupling elements can be axially displaced via the actuating element or elements. For this purpose, the drive assembly can comprise corresponding actuating elements or in particular each coupling element can comprise a respective actuating element. The shift assemblies or synchronizers can comprise actuating apparatuses or sliding sleeves that are axially displaceable on the output shaft but are connected to the output shaft for conjoint rotation, and synchronizing rings that are axially directly adjacent, i.e. arranged on the right and/or left of the actuating apparatus or the sliding sleeve. To actuate the coupling elements, the actuating apparatus, the sliding sleeve or the actuating element can be actuable manually or with power assistance. For this purpose, the drive assembly can comprise, for example, one or more actuators so that the actuating apparatus or actuating element is actuable with power assistance.

In a design embodiment of the disclosure, the drive assembly, preferably the transmission device, particularly the epicyclic transmission stage, specifically the reduced planetary transmission or the first reduced planetary transmission, comprises a third and a fourth shift element. The third and/or the fourth shift element are on the input side connectable, or connected, in particular selectively, to the input shaft. The third shift element can be connectable, or connected, to the first input side, and the fourth shift element can be connectable, or connected, to the second input side. Alternatively or additionally, the third shift element can be designed as the first input side, and the fourth shift element can be designed as the second input side. The drive unit and/or the first energy machine can be connectable, or connected, selectively by way of or through the input shaft and the third or the fourth shift element, to the transmission device, preferably to the epicyclic transmission stage, particularly to the reduced planetary transmission or to the first reduced planetary transmission. The drive unit and/or the first energy machine can be connectable, or connected, to the input shaft, and the input shaft can be connectable, or connected, by way of the, or by the, third shift element to the first input side, or the fourth shift element can be connectable, or connected, to the second input side. Advantageously, owing to the, in particular selective, input-side coupling of the first or the second input side of the transmission device, of the epicyclic transmission stage, particularly of the reduced planetary transmission or of the first reduced planetary transmission, the direction of rotation of the first output side can be set and/or adjusted by way of the third and/or the fourth shift element by the drive unit and/or the first energy machine.

In a design embodiment of the disclosure, the drive assembly comprises a starting module, in particular for electric starting. The starting module can have a fifth shift element. The fifth shift element can be connected on the drive side or on the input side to the input shaft and/or to the first and/or to the second energy machine and/or to the drive unit. Alternatively, the fifth shift element can be connected on the drive side or on the input side to the first output side of the transmission device, preferably of the epicyclic transmission stage, particularly preferably of the reduced planetary transmission or of the first reduced planetary transmission. The fifth shift element can be connected on the driven side or on the output side, to the transmission device, for example by way of a shaft. Alternatively, the fifth shift element can be connectable on the driven side or on the output side to the fourth input side. The starting module can be arranged in the power flow between the first energy machine and the transmission device or can be arranged in the power flow between the first energy machine and a module for reversing the direction of rotation or can be arranged in the power flow between the module for reversing the direction of rotation and the transmission device or in the power flow between the first energy machine and the transmission device. For the optional coupling and decoupling of a drive connection, the starting module for electric starting can be formed between
the first energy machine and the transmission device, or
the first energy machine and the module for reversing the direction of rotation, or
the module for reversing the direction of rotation and the transmission device, or
the first energy machine and the transmission device.

The fifth shift element can be connectable or connected on the drive side and the driven side, to the above-mentioned functional groups, for example by way of shafts. As a result, a serial battery-electric travel range can advantageously be implemented.

In a design embodiment of the disclosure, the drive assembly comprises a set of power electronics, wherein in particular electrical power and/or electrical energy is transmissible between the first and the second energy machine and/or the energy store by the set of power electronics. The set of power electronics can be configured to set and/or adjust and/or actuate the first and the second energy machine and/or the energy store. Specifically, the set of power electronics can be configured to transmit electrical power and/or electrical energy between the first and/or the second energy machine and/or the energy store. The electrical power and/or electrical energy can be transmissible from the first energy machine to the second energy machine and/or to the energy store, and vice versa. The set of power electronics can comprise an electronic control apparatus and/or an inverter and/or a voltage transformer. During operation, the inverter can convert the voltage and/or energy and/or power of the energy store into a voltage and/or energy and/or power required by the energy machines. This procedure can be reversed for charging the energy store. The electronic control apparatus can comprise a computing unit, a computer, a processor, a memory and/or all of the software, hardware, algorithms, connections, and in particular also sensors, which are required for setting and/or adjusting the energy machine. The energy store can be controllable by the electronic control apparatus, alternatively the control unit, in order to store electrical energy and/or power and/or to discharge same to the energy machines. The electronic control apparatus, alternatively the control unit, and/or the energy machines can be electrically connected and/or electrically couplable to the set of power electronics and/or to the energy store. Alternatively, the control unit can be designed as an electronic control apparatus or can comprise the latter and/or take over the tasks of the electronic control apparatus. The control unit and/or the electronic control apparatus can be configured to set and/or to adjust the first and/or second energy machine and/or the energy store, such that the electrical energy or power generated by the first and/or second energy machine and/or the electrical energy or power stored in the energy store is discharged.

In a refinement of the disclosure, a separating clutch is arranged between the drive unit and the transmission device or between the drive unit and the first energy machine. By using the separating clutch between the drive unit and the transmission device or the first energy machine, the drive unit can be decoupled from the drive assembly. As a result, the drive assembly can advantageously be operated in a battery-electric driving range, i.e. in particular a hybrid drive of the drive assembly can be realized.

In a refinement of the disclosure, the drive assembly comprises a control unit, the drive assembly being operable with the control unit. Alternatively or additionally, the work machine comprises the control unit, wherein the work machine and/or the drive assembly is operable with the control unit. In other words, the control unit is configured to operate the work machine and/or the drive assembly, in particular the drive unit. The control unit can be connected to the first and/or the second energy machine and/or the drive unit for signalling, and/or operatively coupled thereto and/or connected thereto for transmitting signals and/or carrying data. The control unit can be configured to receive one or more rotational speed signals and/or torque signals from the drive assembly, in particular from rotational speed and/or torque sensors of the drive assembly, and/or from the first and/or the second energy machine and/or from the drive unit. The control unit can be configured to determine a rotational speed and/or a torque with the rotational speed signal and/or the torque signal. The control unit can be configured to set and/or adjust the rotational speed and/or the torque of the drive assembly, in particular of the first and/or second energy machine and/or to the drive unit, in particular to set and/or adjust a specifiable rotational speed and/or a specifiable torque. Further details of the control unit are described above and hereunder.

In a refinement of the disclosure, the input shaft is connected to a first power output. The drive unit and/or the first energy machine can be connected to the input shaft. The drive unit and/or the first energy machine can be connectable or connected to the first power output via the or by the input shaft. The first power output can comprise a power take-off unit, or be designed as a power take-off unit. The power take-off unit can comprise a power take-off transmission and/or a power take-off shaft. The drive unit and/or the first energy machine can be connectable or connected to the first power output, preferably to the power take-off unit, particularly to the power take-off transmission and/or the power take-off shaft, in particular via the input shaft. The first power output, preferably the power take-off unit, particularly the power take-off transmission and/or the power take-off shaft, is drivable with the drive unit and/or the first energy machine. The control unit can be configured to set and/or adjust the rotational speed of the first power output. The drive assembly can have one passage or a plurality of passages, in particular one or more central passages, for the input shaft. The passage or the passages, in particular the central passage or passages, can be designed as one or more shaft leadthroughs, in particular one or more central shaft leadthroughs, for the input shaft. The transmission device and/or the dual-clutch transmission and/or the starting module and/or the module for reversing the direction of rotation can thus have one or a plurality of shaft leadthroughs, in particular one or more central shaft leadthroughs, for the input shaft. Specifically:
the first and/or the second and/or the third and/or the fourth and/or the fifth and/or any further shift element and/or the first and the second transmission input shaft, and/or
the transmission device, preferably the epicyclic transmission stage, particularly preferably the first reduced planetary transmission, in particular the suns thereof, and/or
the first and/or the second transmission stage, and/or the further shafts
the clutch device and/or the separating clutch
   can each have passages, in particular shaft leadthroughs, for the input shaft. As a result, a compact and/or modular and/or structurally simple design of the drive assembly, in particular of the first power output, can advantageously be achieved.

The disclosure furthermore relates to a work machine, comprising a drive assembly, in particular a drive assembly according to one or more embodiments disclosed herein. The work machine can be a construction machine or a towing vehicle, preferably an agricultural towing vehicle, for example a tractor or agricultural tractor. The work machine has the above-described advantages of the drive assembly. The work machine comprises the drive assembly. The drive assembly is designed for driving the work machine. The work machine can comprise one, two or more axles. The work machine can be drivable with a rotational speed and/or force and/or a torque of the drive unit.

The control unit can be configured for controlling, by open-loop and/or closed-loop control, in particular setting and/or adjusting, the work machine, in particular the drive unit. The work machine can comprise an input and output unit. The control unit can be connected to the input and output unit for signalling, and/or operatively coupled thereto and/or connected thereto for transmitting signals and/or carrying data, and/or can be controllable and/or settable and/or adjustable with the input and output unit. The input and output unit can be integrated in the control unit, or vice versa. The operator of the work machine can set and/or adjust a speed of the work machine, for example, with the or by the input and output unit. The control unit can be configured to set and/or adjust the first and/or the second energy machine and/or the stator, in particular in such a way that they are electrically driven.

The work machine can, moreover, comprise one or more auxiliary units, for example a pump and/or a cooler, etc. The auxiliary units can be part of the hydraulic system of the drive assembly. The work machine can comprise the first power output, in particular the power take-off unit. The control unit can be configured to set and/or adjust and/or control the drive assembly and/or the work machine by means of a driving signal and to set and/or adjust, in particular to increase or reduce, a speed of the work machine by means of or based on the driving signal. The work machine can comprise the one or more ground-engaging means. The ground-engaging means can support and/or carry the work machine on the ground. A towing vehicle frame of the work machine can be supported on the ground-engaging means. The ground-engaging means can be wheels or tracks or chains. In particular, the ground-engaging means can be front wheels and rear wheels. The work machine can comprise a speed sensor, for example a rotational speed sensor, for detecting a speed of the work machine. Specifically, the control unit can be configured to set and/or to adjust and/or to control a force and/or a torque and/or a rotational speed of the drive unit and/or of the first and/or the second energy machine by means of the driving signal or a plurality of driving signals.

The shift elements, in particular the valves or valve devices or actuators thereof, and/or the drive unit and/or the first power output, in particular the power take-off unit, and/or the first and/or the second energy machine and/or the energy store and/or the set of power electronics can be controllable and/or settable and/or adjustable, preferably controllable, by open-loop and/or closed-loop control, by means of the control unit. The control unit can transmit and/or receive signals for controlling the operation of the drive assembly and/or the work machine. Expediently, the signals can be provided via a suitable data communication network, for example one which complies with the ISOBUS and/or CAN standard. The control unit can be designed as an electronic module, an embedded system, a computing unit, a computer, as a module for open-loop and/or closed-loop control of the drive assembly and/or the work machine. The control unit can comprise one or more processors, a memory and/or all of the software, hardware, algorithms, connections, and in particular also sensors, that are required for the open-loop and/or closed-loop control of the drive assembly and/or the work machine. Methods can take the form of a program or algorithm which can be executed on and/or by the control unit. The control unit can comprise any apparatus that analyses data from various sensors, compares data, and makes the decisions necessary to control, by open-loop and/or closed-loop control, and/or to carry out the operation of the drive assembly and/or the work machine, and the necessary tasks for controlling, by open-loop and/or closed-loop control, the operation of the drive assembly and/or the work machine. The control unit can be connected to the components of the drive assembly and/or the work machine, i.e. in particular to the shift elements, in particular the valves or valve devices or actuators thereof, and/or to the drive unit and/or to the first power output, in particular the power take-off unit, and/or the first and/or second energy machine and/or to the energy store and/or the set of power electronics and/or the sensors for signalling and/or operatively coupled thereto and/or connected for transmitting signals and/or for carrying data. Connected for signalling and/or operatively coupled and/or connected for transmitting signals and/or for carrying data can be understood to mean, inter alia, that signals and/or data can be exchanged between the connected components and the control unit. Signals can, for example, be received and sent, and/or processed and/or handled, by the control unit. The connection between the control unit and the parts or components of the drive assembly and/or of the work machine can be implemented by wire, i.e. in particular using cables, and/or in a wireless manner, i.e. by radio, for example using Bluetooth or WLAN.

The connection between the control unit and the parts or components of the drive assembly and/or of the work machine can be realized, for example, by a local network (LAN), a radio access network (RAN), a Metropolitan Area Network (MAN), a Wide Area Network (WAN), Worldwide Interoperability for Microwave Access (WIMAX), or a wireless local area network (WLAN). Communication can take place, for example, by means of Isobus, CAN bus, or the like. The control unit can be connected directly to an input and output unit, in particular to the input and output unit arranged in a cab of the work machine, by means of which data entered by an operator can be transmitted to the control unit, or data can be received from the latter and output. The control unit can be integrated in the input and output unit, or vice versa.

Other features and aspects will become apparent by consideration of the detailed description, claims, and accompanying drawings.

### BRIEF DESCRIPTION OF THE DRAWINGS

The disclosure and further advantages and advantageous developments and refinements of the disclosure, both in terms of hardware and in terms of method, will be explained in more detail below on the basis of exemplary embodiments and with reference to the drawing. Components with an equivalent or comparable function herein are identified by the same reference signs.

FIG. 1 shows a schematic illustration of a first exemplary embodiment of a work machine according to the disclosure, and

FIG. 2 shows a schematic illustration of the first exemplary embodiment of the drive assembly according to the disclosure, and

FIG. 3 shows a schematic illustration of a second exemplary embodiment of the drive assembly according to the disclosure, and

FIG. 4 shows a schematic illustration of a third exemplary embodiment of the drive assembly according to the disclosure, and

FIG. 5 shows a schematic illustration of a fourth exemplary embodiment of the drive assembly according to the disclosure.

Like reference numerals are used to indicate like elements throughout the several figures.

### DETAILED DESCRIPTION

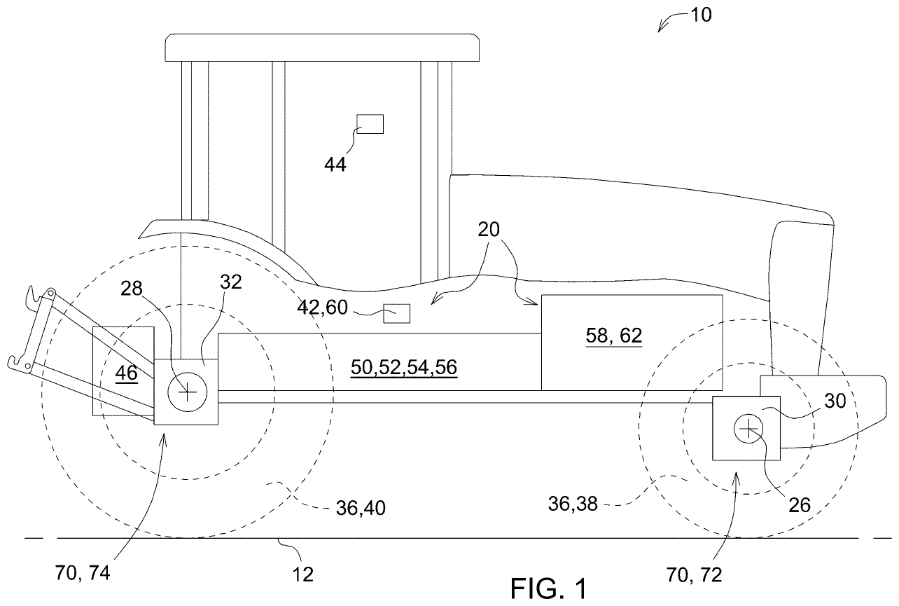

FIG. 1 shows a schematic illustration of a first exemplary embodiment of a work machine 10 according to the disclosure, here an agricultural towing vehicle or tractor or agricultural tractor, having a drive assembly 20 according to the disclosure. The work machine 10 is drivable by the drive assembly 20. The drive assembly 20 comprises a transmission device 50 and a dual-clutch transmission 52 mounted in the power flow downstream of the transmission device 50, wherein at least one gear of the dual-clutch transmission is in the form of a winding path gear. The drive assembly 20 furthermore comprises a first and second energy machine 54, 56 and an input shaft 86 and an output shaft 88.

The work machine 10, or in particular the drive assembly 20, comprises a first vehicle axle 26 and a second vehicle axle 28. The first vehicle axle 26 can be a front axle, and the second vehicle axle 28 can be a rear axle. Moreover, the first vehicle axle 26 can be designed as a steerable axle. The work machine 10 can have one or more ground-engaging means 36, in this case in the form of wheels 38, 40, which engage with an underlying surface 12 in order to transmit drive forces and/or by way of which the work machine 10 is supported on the underlying surface 12. The work machine 10, in particular the drive assembly 20, can comprise a travel drive 70, in particular a front-axle drive 72 and a rear-axle drive 74. The travel drive 70 can comprise the first vehicle axle 26 and/or the second vehicle axle 28 and/or a first differential 30 and/or a second differential 32 and/or the one or more ground-engaging means 36. The front-axle drive 72 an comprise the first vehicle axle 26, and/or the first differential 30, i.e. in particular a front-axle differential, and/or the one or more ground-engaging means 36. The rear-axle drive 74 can comprise the second vehicle axle 28, and/or the second differential 32, i.e. in particular a rear-axle differential, and/or the one or more ground-engaging means 36. The first vehicle axle 26 can be connected to the first differential 30. The second vehicle axle 28 can be connected to the second differential 32.

The output shaft 88 can be connected to the propulsion drive 76, in particular to the first and/or the second differential 30, 32, in particular to the second differential 32. The output shaft 88 can be connected to the second vehicle axle 28 via the second, or with the second, differential 32. A force and/or a torque and/or a rotational speed can be transmissible from the drive output 54 to the first and/or the second vehicle axle 26, 28, and thus in particular to the ground-engaging means 36, via the first, or with the first, differential 30 and/or via the second, or with the second, differential 32. The drive assembly 20 or the work machine 10 can comprise a drive unit 58. The drive unit 58 can be connectable or connected to the input shaft 86. With the drive assembly 20, in particular the drive unit 58, a rotational movement and/or force and/or a torque and/or a rotational speed can be generable and can be transmissible, in particular via the transmission device 50 and the dual-clutch transmission 52, to the output shaft 88, to the first and/or second vehicle axle 26, 28. The first and/or the second vehicle axle 26, 28 convert the rotational movement and/or force and/or the torque and/or the rotational speed into a rotational movement and/or force and/or a torque and/or rotational speed of one or more ground-engaging means 36, and thus into thrust of the work machine 10. The work machine 10 can, moreover, comprise a towing vehicle frame. The towing vehicle frame can in particular be supported by the ground-engaging means 36 suspended on the first and/or the second vehicle axle 28, 30, in particular the wheels 38, 40. Specifically, a first pair of wheels 38 are arranged on the first vehicle axle 26, and a second pair of wheels 40 on the second vehicle axle 28. Here, the diameters of the wheels 38, 40 may differ; in particular, the diameter of the first pair of wheels 38 may be smaller than the diameter of the second pair of wheels 40. Alternatively, the ground-engaging means 36 can also be designed and arranged as tracks or chains.

The work machine 10, in particular the drive assembly 20, can comprise a first power output 46. The first power output 46 can comprise a power take-off unit 108. The first power output 46 can be provided for driving a working implement (not shown) which is attachable to the work machine 10 via an interface (e.g. three-point interface). The work machine 10, in particular alternatively or additionally the drive assembly 20, can comprise a control unit 42 and/or an input and output unit 44. The control unit 42 can be connected to the input and output unit 44 for signaling, and/or operatively coupled thereto and/or connected thereto for transmitting signals and/or carrying data. Specifically, the control unit 42 can be connected directly to the input and output unit 44 arranged in a cab of the work machine 10, by means of which data entered by an operator can be transmitted to the control unit 42, or data can be received from the latter and output. The drive assembly 20, and/or in particular the work machine 10, can be settable and/or adjustable with the control unit 42. The control unit 42 is connected to the drive unit 58 and/or to the first and/or the second energy machine 54, 56 for signaling, and/or operatively coupled thereto and/or connected thereto for transmitting signals and/or carrying data.

The control unit 42 is configured to set and/or adjust the rotational speed and/or the torque and/or the force of the drive assembly 20, in particular the drive unit 58 and/or the first and/or second energy machine 54, 56, in particular to actuate the latter and/or to control the latter, by open-loop and/or closed-loop control. The control unit 42 can be configured to set and/or adjust a specifiable rotational speed and/or a specifiable torque and/or a specifiable force of the drive assembly 20, in particular the drive unit 58 and/or the first and/or second energy machine 54, 56, in particular to actuate the latter and/or to control the latter, by open-loop and/or closed-loop control. The control unit 42 can be configured to set and/or adjust the drive assembly 20, in particular alternatively or additionally the work machine 10, in order to set and/or to adjust, in particular to control, by open-loop and/or closed-loop control, the rotational speed and/or the torque and/or the force of the drive unit 58.

Moreover, the work machine 10, alternatively or additionally the drive assembly 20, can comprise a set of power electronics 60 in order to transmit the electrical power or energy between the first and/or the second energy machine 54, 56 and an energy store 62, here, for example, a battery (rechargeable battery). The control unit 42 can be connected to the set of power electronics 60 and to the energy store 62 for signaling, and/or operatively coupled thereto and/or connected thereto for transmitting signals and/or carrying data. The energy store 62 can supply the electrically driven components of the drive assembly 20 with currents or voltages of suitable frequency and amplitudes in order to provide desired output rotational speeds or torques for the first power output 46 and/or the drive assembly 20.

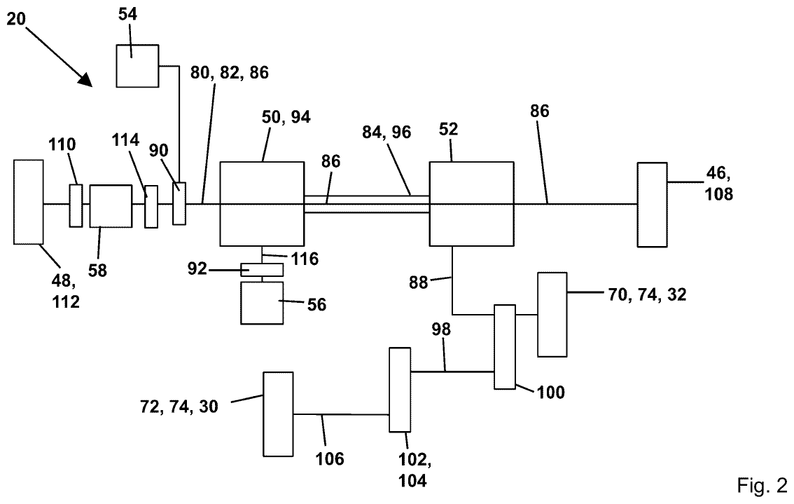

FIG. 2 shows a schematic illustration of a first exemplary embodiment of the drive assembly 20 according to the disclosure. The drive assembly 20 shown in FIG. 2 corresponds substantially to the drive assembly 20 shown in FIG. 1, and therefore only details and/or points of differentiation will be discussed below. The work machine 10 illustrated in FIG. 1 can comprise the drive assembly 20 illustrated in FIG. 2. The drive assembly 20 for a work machine 10 comprises the transmission device 50 with a first and second input side 80, 82 and a first output side 84 and the dual-clutch transmission 52. The dual-clutch transmission 52 is connectable, or connected, to the first output side 84 of the transmission device 50, for example with a or by a shaft 96 which can preferably be designed as a hollow shaft. The drive assembly 20 furthermore comprises the input shaft 86 and the output shaft 88.

The input shaft 86 can be connectable, or connected, to the first or the second input side 80, 82. The first energy machine 54 is connected to the input shaft 86. The first energy machine 54 can be connected to the input shaft 86 directly or by way of a, or with a, or by a, first transmission stage 90. In addition, the drive unit 58 can be connectable or connected to the input shaft 86. The drive unit 58 and/or the first energy machine 54 is connectable, or connected, to the first or the second input side 80, 82 by way of, or through, the input shaft 86 in such a way that in particular a rotating speed and/or a direction of rotation of the first output side 84 of the transmission device 50 is settable and/or adjustable and/or actuable.

A separating clutch 114 can be arranged between the drive unit 58 and the transmission device 50 or between the drive unit 58 and the first energy machine 54. A rotational speed and/or a torque and/or a force can thereby optionally be introducible into the drive assembly 20, in particular the transmission device 50, by the drive unit 58. The transmission device 50 can be arranged in the torque flow and/or power flow upstream of the dual-clutch transmission 52.

The second energy machine 56 is connectable, or connected, to the transmission device 50. The second energy machine 56 is connected to the third input side 116. The second energy machine 56 can be connected to the third input side 116 directly or by way of a or with a second or by a second transmission stage 92. In addition, the input shaft 86 is connected to the first power output 46.

Moreover, a rotating speed and/or a direction of rotation of the first output side 84 of the transmission device 50 is settable and/or adjustable and/or actuable, preferably a rotating speed and/or a direction of rotation of the first output side 84 of the transmission device 50 is settable and/or adjustable and/or actuable by the second energy machine 56. In other words, a rotational speed and/or a direction of rotation, and/or in particular a rotation, of the second energy machine 56 can be settable and/or adjustable and/or controllable, in particular in such a way that a rotational speed and/or a direction of rotation, and/or in particular a rotation, of the first output side 84 of the transmission device 50 is settable and/or adjustable and/or controllable.

The transmission device 50 can be designed as an epicyclic transmission stage 94. The transmission device 50, in particular the epicyclic transmission stage 94, can comprise a planetary transmission, in particular a first planetary transmission, or a reduced planetary transmission 118, in particular a first reduced planetary transmission, and/or can be designed as a planetary transmission, in particular the first planetary transmission, or a reduced planetary transmission 118, in particular the first planetary transmission. The reduced planetary transmission 118, in particular the first reduced planetary transmission, can comprise a positive and a negative planetary stage, preferably be designed as a combined positive and a negative planetary stage.

The dual-clutch transmission 52 is connectable or connected on the driven side to the output shaft 88. The output shaft 88 can, moreover, be connectable or connected to the travel drive 70, preferably to the rear-axle drive 74, particularly to the first and/or second differential 30, 32. The output shaft 88 can also be connectable or connected to a countershaft 98, in particular via a or by a third transmission stage 100, for example a further cylindrical gear stage or a further gearwheel pair or three or more gearwheels or a further planetary transmission or another transmission. Moreover, the countershaft 98 can be connectable or connected to the travel drive 70, preferably to the front-axle drive 72, particularly to the first differential 30. The countershaft 98 can be connectable or connected to a further shaft 106 with a fourth or via a fourth transmission stage 102, for example a further cylindrical gear stage or a further gearwheel pair, or three or more gearwheels, or a further planetary transmission or another transmission, and/or a further shift element 104. The drive assembly 20 can, moreover, comprise the first power output 46.

The drive unit 58 and/or the first energy machine 54 can be connectable or connected to the first power output 46. Specifically, the drive unit 58 and/or the first energy machine 54 can be connectable or connected to the first power output 46 via the or by the input shaft 86. The input shaft 86 can be connectable or connected to the first power output 46, for example, with a further shift element (not shown). The first power output 46 can comprise a power take-off unit 108. The power take-off unit 108 can comprise a power take-off transmission and/or a power take-off shaft. The power take-off unit 108, in particular the power take-off transmission, can be connected on the drive side to the input shaft 86. Moreover, the power take-off unit 108, in particular the power take-off transmission, can be connectable or connected on the driven side to the power take-off shaft. The transmission device 50 and/or the dual-clutch transmission 52 can have one or a plurality of passages or shaft leadthroughs, in particular one or a plurality of central passages or shaft leadthroughs, for the input shaft 86. The drive assembly 20 can, moreover, comprise a second power output 48. The drive unit 58 and/or the first energy machine 54 can be connectable or connected to the second power output 48. Specifically, the drive unit 58 and/or the first energy machine 54 can be connectable or connected to the second power output 48 via a further shaft or the input shaft 86. The drive unit 58 and/or the first energy machine 54 can be connected to the second power output 48 via the further shaft or the input shaft 86 and/or with a further shift element 110. The second power output 48 can comprise a further power take-off unit 112. The further power take-off unit 112 can comprise a further power take-off transmission and/or a further power take-off shaft. FIG. 2 schematically describes the power flux of the drive assembly 20 to the output shaft 88.

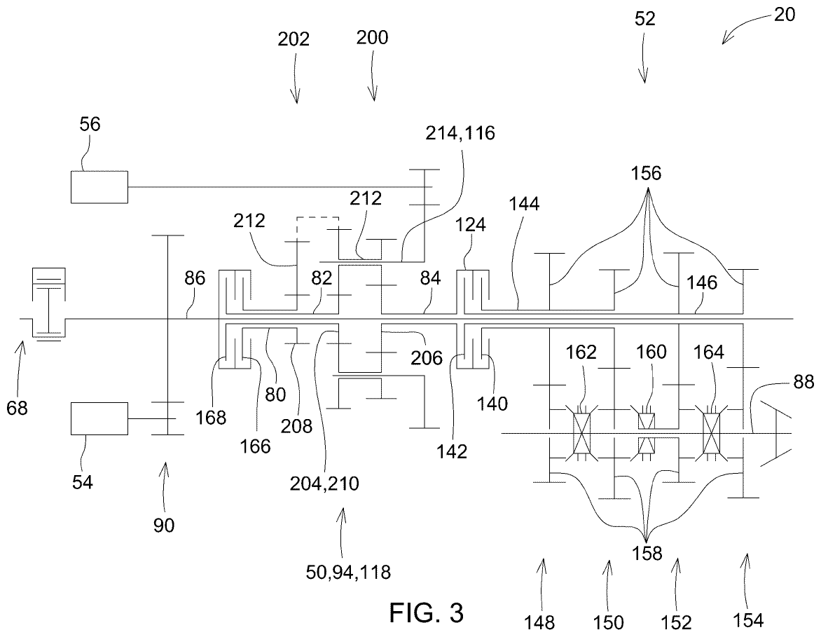

FIG. 3 shows a schematic illustration of the second exemplary embodiment of the drive assembly 20 according to the disclosure. The drive assembly 20 shown in FIG. 3 corresponds substantially to the drive assembly 20 shown in FIGS. 1 to 2, and therefore only details and/or points of differentiation will be discussed below. The work machine 10 illustrated in FIG. 1 can comprise the drive assembly 20 illustrated in FIG. 3.

The dual-clutch transmission 52 comprises a first and second shift element 140, 142. The first shift element 140 is connected to a first transmission input shaft 144, and the second shift element 142 is connected to a second transmission input shaft 146. The dual-clutch transmission 52 comprises four cylindrical gear stages 148, 150, 152, 154 each having a fixed gear 156 arranged on the first or second transmission input shaft 144, 146 for conjoint rotation and each having a shift gear 158 arranged rotatably on the output shaft 88. The dual-clutch transmission 52 has four cylindrical gear stages 148, 150, 152, 154 for setting up gear ratio stages. Specifically, a first cylindrical gear stage 148 and a second cylindrical gear stage 150 each have the fixed gear 156 on the first transmission input shaft 144 and each have the shift gear 158 on the output shaft 88. A third cylindrical gear stage 152 and a fourth cylindrical gear stage 154 can each have the fixed gear 156 on the second transmission input shaft 146 and can each have the shift gear 158 on the output shaft 88.

The dual-clutch transmission 52 moreover comprises the first coupling element 160. The first coupling element 160 is arranged on the output shaft 88 between the second and the third cylindrical gear stages 150, 152, and is mounted on the output shaft 88. The two shift gears 158 of the second and third cylindrical gear stages 150, 152 can be connected for conjoint rotation to the first coupling element 160 in such a way that the first and the second transmission input shafts 144, 146 are placed in dependence on one another and a winding path gear ratio stage is formed. The second coupling element 162 can be arranged between the first and the second cylindrical gear stages 148, 150 on or at the output shaft 88. The third coupling element 164 can be arranged between the third and the fourth cylindrical gear stages 152, 154 on or at the output shaft 88. The shift gear 158 of the first cylindrical gear stage 148 can be connected for conjoint rotation to the output shaft 88 by the second coupling element 162. The shift gear 158 of the fourth cylindrical gear stage 154 can be connected for conjoint rotation to the output shaft 88 by the third coupling element 164. On the driven side, the output shaft 88 is assigned to the dual-clutch transmission 52. The dual-clutch transmission is connected on the input side to the first output side 84. The first and/or the second transmission input shaft 144, 146 are designed as hollow shafts. The input shaft 86 is designed as a solid shaft. The second transmission input shaft 146 is arranged and/or mounted in the first transmission input shaft 144, in particular arranged and/or mounted so as to be able to freely rotate, and the input shaft 86 is arranged and/or mounted in the second transmission input shaft 146, in particular arranged and/or mounted so as to be able to freely rotate.

The drive assembly 20 or the transmission device 50, preferably the epicyclic transmission stage 94, particularly the first reduced planetary transmission 118, comprises a third and a fourth shift element 166, 168. The third and the fourth shift element 166, 168 are connectable, or connected, on the input side to the input shaft 86. The third and the fourth shift elements 166, 168 are designed as clutches.

The transmission device 50, in particular the epicyclic transmission stage 94, comprises the reduced planetary transmission 118, in particular a first reduced planetary transmission, and/or can be designed as the reduced planetary transmission 118, in particular the first reduced planetary transmission.

The transmission device 50, preferably the epicyclic transmission stage 94, particularly the reduced planetary transmission 118, comprises and/or is designed as a positive planetary stage 200 with a first sun 204 and a second sun 206 combined with a negative planetary stage 202 with a third and a fourth sun 208, 210 and a first intermediate planet 212 and a first planet carrier 214. The first and the fourth sun 204, 210 are designed as a common sun.

The drive unit 58 and/or the first energy machine 54 can be connectable, or connected, by way of or through the input shaft 86, and selectively be connectable or connected by the third shift element 166 to the third sun 208, in particular the small sun, of the negative planet set 202, or by the fourth shift element 168 to the first sun 204, in particular the small sun, of the positive planet set 200. Alternatively or additionally, the first shift element 166 can be designed as the first input side 80, or be connected thereto, and/or the second shift element 168 can be designed as the second input side 82, or be connected thereto.

The first input side 80 of the transmission device 50, preferably of the epicyclic transmission stage 94, particularly of the reduced planetary transmission 118, can be the third sun 208, in particular the small sun, of the negative planet set 202. Alternatively or additionally, the first input side 80 can be connectable, or connected, to the third sun 208. The third sun 208 of the negative planet set 202 can be connectable, or connected, to the input shaft 86. The third sun 208 can be connectable, or connected, to the input shaft 86, through or by a shaft. The third sun 208 can be connectable, or connected, to the input shaft 86 through or by way of the third shift element 166. The third shift element 166 is connected on the input side to the input shaft 86, and connectable on the output side to the third sun 208.

The second input side 82 of the transmission device 50, preferably of the epicyclic transmission stage 94, particularly of the reduced planetary transmission 118, can be the first sun 204. Alternatively or additionally, the second input side 82 can be connected to the first sun 204, in particular the small sun, of the positive planet set 200. The first sun 204 of the positive planet set 200 can be connectable, or connected, to the input shaft 86. The first sun 204 can be connectable, or connected, to the input shaft 86 through or by a shaft. The first sun 204 can be connectable, or connected, to the input shaft 86 through or by way of the fourth shift element 168. The fourth shift element 168 is connected on the input side to the input shaft 86, and connectable on the output side to the first sun 204.

The third input side 116 of the transmission device 50, preferably of the epicyclic transmission stage 94, particularly of the reduced planetary transmission 118, can be connectable, or connected, to the second energy machine 56. The second energy machine 56 can be connectable, or connected, to the first planet carrier 214 of the negative planetary stage 202. The third input side 116 can be the first planet carrier 208. Alternatively or additionally, the third input side 116 can be connectable, or connected, to the first planet carrier 208. The first planet carrier 208 can be connectable, or connected, to the second energy machine 56 through a, or by a, shaft and/or the second transmission stage 92.

The first output side 84 of the transmission device 50, preferably of the epicyclic transmission stage 94, particularly of the reduced planetary transmission 118, can be the second sun 206, in particular the large sun, of the positive planetary stage 200. Alternatively or additionally, the first output side 84 can be connectable, or connected, to the second sun 206. The second sun 206 can be connected to the dual-clutch transmission 52, preferably connected to the fourth input side 124 of the dual-clutch transmission 52 or to an input side of the first and the second shift element 140, 142. The second sun 206 can be connected to the dual-clutch transmission 52, in particular to the fourth input side 124 or to an input side of the first and the second shift element 140, 142, through or by a shaft.

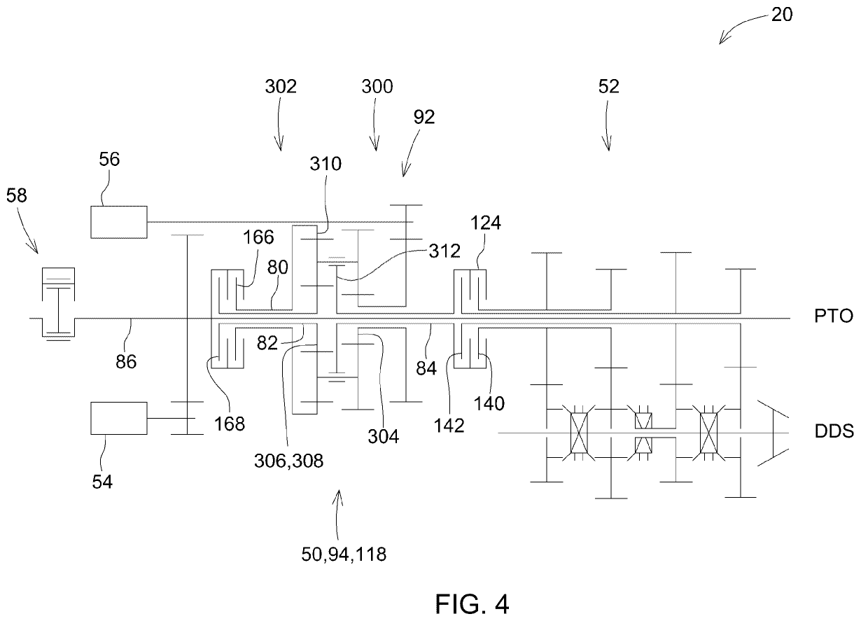

FIG. 4 shows a schematic illustration of the third exemplary embodiment of the drive assembly 20 according to the disclosure. The drive assembly 20 shown in FIG. 4 corresponds substantially to the drive assembly 20 shown in FIGS. 1 to 3, and therefore only details and/or points of differentiation will be discussed below. The work machine 10 illustrated in FIG. 1 can comprise the drive assembly 20 illustrated in FIG. 4.

The transmission device 50, preferably the epicyclic transmission stage 94, particularly the reduced planetary transmission 118, comprises and/or is designed as a positive planetary stage 300 with a first sun 304 and a second sun 306 combined with a negative planetary stage 302 with a third sun 308 and a first ring gear 310 and a first planet carrier 312. The second and the third sun 306, 308 are designed as a common sun.

The drive unit 58 and/or the first energy machine 54 can be connectable, or connected, by way of or through the input shaft 86, and selectively be connectable or connected through the third shift element 166, to the first ring gear 310 of the negative planet set 302, or through the fourth shift element 168 to the second sun 306, in particular the large sun, of the positive planet set 300.

The first input side 80 of the transmission device 50, preferably of the epicyclic transmission stage 94, particularly of the reduced planetary transmission 118, can be the first ring gear 310. Alternatively or additionally, the first input side 80 can be connected to the first ring gear 310 of the negative planet set 302. The first ring gear 310 of the negative planet set 302 can be connectable, or connected, to the input shaft 86. The first ring gear 310 can be connectable, or connected, to the input shaft 86 through a, or by a shaft. The first ring gear 310 can be connectable, or connected to the input shaft 86 through or by way of the third shift element 166. The third shift element 166 is connected on the input side to the input shaft 86, and connectable on the output side to the first ring gear 310.

The second input side 82 of the transmission device 50, preferably of the epicyclic transmission stage 94, particularly of the reduced planetary transmission 118, can be the second sun 306, in particular the large sun, of the positive planet set 300. Alternatively or additionally, the second input side 82 can be connectable, or connected, to the second sun 306. The second sun 306 of the positive planet set 300 can be connectable, or connected, to the input shaft 86. The second sun 306 can be connectable, or connected, to the input shaft 86 with a, or by a, shaft. The second sun 306 can be connectable, or connected, to the input shaft 86 through or by way of the fourth shift element 168. The fourth shift element 168 is connected on the input side to the input shaft 86, and connectable on the output side to the second sun 306.

The third input side 116 of the transmission device 50, preferably of the epicyclic transmission stage 94, particularly of the reduced planetary transmission 118, can be connectable, or connected, to the second energy machine 56. The second energy machine 56 can be connectable, or connected, to the first sun 304, in particular the small sun, of the positive planetary stage 300. The third input side 116 can be the first sun 304. Alternatively or additionally, the third input side 116 can be connectable, or connected, to the first sun 304. The first sun 304 can be connectable, or connected, to the second energy machine 56 through a, or by a shaft and/or the second transmission stage 92.

The first output side 84 of the transmission device 50, preferably of the epicyclic transmission stage 94, particularly of the reduced planetary transmission 118, can be the first planet carrier 312 of the positive planetary stage 300. Alternatively or additionally, the first output side 84 can be connectable, or connected, to the first planet carrier 312. The first planet carrier 312 can be connected to the dual-clutch transmission 52, preferably connected to the fourth input side 124 of the dual-clutch transmission 52 or to an input side of the first and the second shift element 140, 142. The first planet carrier 312 can be connected to the dual-clutch transmission 52, in particular to the fourth input side 124 or to an input side of the first and the second shift element 140, 142 through a, or by a, shaft.

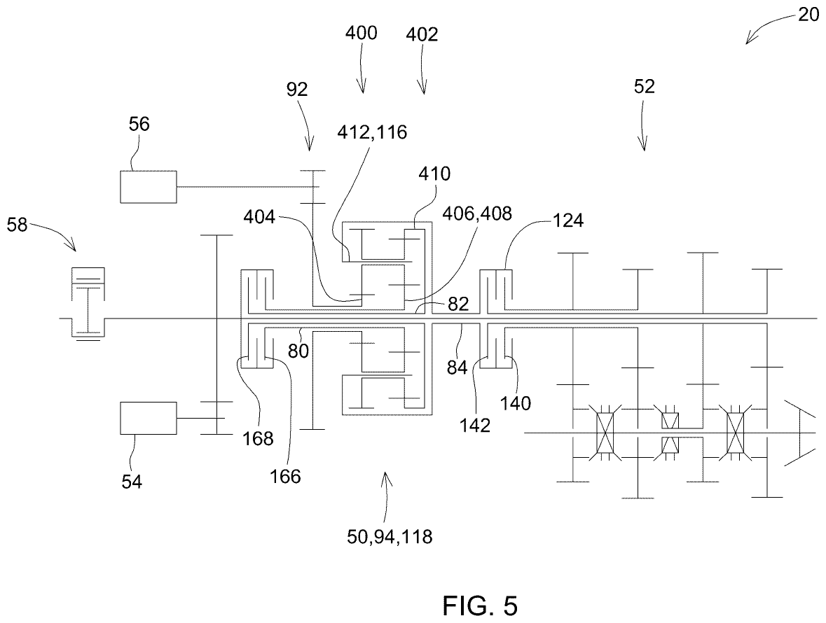

FIG. 5 shows a schematic illustration of the fourth exemplary embodiment of the drive assembly 20 according to the disclosure. The drive assembly 20 shown in FIG. 5 corresponds substantially to the drive assembly 20 shown in FIGS. 1 to 4, and therefore only details and/or points of differentiation will be discussed below. The work machine 10 illustrated in FIG. 1 can comprise the drive assembly 20 illustrated in FIG. 5.

The transmission device 50, preferably the epicyclic transmission stage 94, particularly the reduced planetary transmission 118, comprises and/or is designed as a positive planetary stage 400 with a first sun 404 and a second sun 406 combined with a negative planetary stage 402 with a third sun 408 and a first ring gear 410 and a first planet carrier 412.

The drive unit 58 and/or the first energy machine 54 can be connectable, or connected, by way of or through the input shaft 86, and selectively be connectable or connected through the third shift element 166 to the second sun 406, in particular the large sun, of the positive planet set 400, or through the fourth shift element 168 to the first ring gear 410 of the negative planet set 402.

The first input side 80 of the transmission device 50, preferably of the epicyclic transmission stage 94, particularly of the reduced planetary transmission 118 can be the second sun 406. Alternatively or additionally, the first input side 80 can be connected to the second sun 406 of the positive planet set 400. The second sun 406 of the positive planet set 400 can be connectable, or connected, to the input shaft 86. The second sun 406 can be connectable, or connected, to the input shaft 86 with a, or by a, shaft. The second sun 406 can be connectable, or connected, to the input shaft 86 through or by way of the third shift element 166. The third shift element 166 is connected on the input side to the input shaft 86, and connectable or connected on the output side to the second sun 406.

The second input side 82 of the transmission device 50, preferably of the epicyclic transmission stage 94, particularly of the reduced planetary transmission 118, can be the first ring gear 410 of the negative planet set 402. Alternatively or additionally, the second input side 82 can be connectable, or connected, to the first ring gear 410. The first ring gear 410 of the negative planet set 402 can be connectable, or connected, to the input shaft 86. The first ring gear 410 can be connectable, or connected, to the input shaft 86 through a, or by a shaft. The first ring gear 410 can be connectable, or connected, to the input shaft 86 through, or by way of, the fourth shift element 168. The fourth shift element 168 is connected on the input side to the input shaft 86, and connectable or connected on the output side to the first ring gear 410.

The third input side 116 of the transmission device 50, preferably of the epicyclic transmission stage 94, particularly of the reduced planetary transmission 118, can be connectable, or connected, to the second energy machine 56. The second energy machine 56 can be connectable, or connected, to the first sun 404 of the positive planetary stage 400. The third input side 116 can be the first sun 404. Alternatively or additionally, the third input side 116 can be connectable, or connected, to the first sun 404. The first sun 404 can be connectable, or connected, to the second energy machine 56 through a, or by a shaft and/or the second transmission stage 92.

The first output side 84 of the transmission device 50, preferably of the epicyclic transmission stage 94, particularly of the reduced planetary transmission 118, can be the first planet carrier 412. Alternatively or additionally, the first output side 84 can be connectable, or connected, to the first planet carrier 412. The first planet carrier 412 can be connected to the dual-clutch transmission 52, preferably connected to the fourth input side 124 of the dual-clutch transmission 52 or to an input side of the first and the second shift element 140, 142. The first planet carrier 412 can be connected to the dual-clutch transmission 52, in particular to the fourth input side 124 or to an input side of the first and the second shift element 140, 142 through a, or by a, shaft.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A drive assembly for a work machine, comprising:
a transmission device having a first input side, a second input sides, and a first output side,
a dual-clutch transmission, wherein at least one gear is embodied as a winding path gear, and the dual-clutch transmission is connectable, or connected, to the first output side of the transmission device,
an input shaft,
an output shaft,
a drive unit connectable, or connected, to the input shaft,
a first energy machine connectable, or connected, to the input shaft,
a second energy machine connectable, or connected, to the transmission device,
wherein the drive unit is connectable, or connected, to the first or the second input side in such a way that a rotating speed or a direction of rotation of the first output side of the transmission device is settable, adjustable, or actuable.

2. The drive assembly of claim 1, wherein a rotating speed or a direction of rotation of the first output side of the transmission device is settable, adjustable, or actuable by the second energy machine.

3. The drive assembly of claim 1, wherein the transmission device is in the form of an epicyclic transmission stage.

4. The drive assembly of claim 1, wherein the dual-clutch transmission includes a first shift element and a second shift element, the first shift element is connected to a first transmission input shaft, the second shift element is connected to a second transmission input shaft, and the dual-clutch transmission includes a plurality of cylindrical gear stages each having a fixed gear arranged for conjoint rotation on the first or second transmission input shaft and each having a shift gear arranged rotatably on the output shaft.

5. The drive assembly of claim 4, further comprising a third shift element and a fourth shift element, and the third and the fourth shift elements are connectable, or connected, on the input side to the input shaft.

6. The drive assembly of claim 1, further comprising a starting module for electric starting.

7. The drive assembly of claim 1, further comprising a set of power electronics with which electrical power is transmissible between the first energy machine and the second energy machine.

8. The drive assembly of claim 1, wherein a separating clutch is arranged between the drive unit and the transmission device or between the drive unit and the first energy machine.

9. The drive assembly of claim 1, further comprising a control unit, wherein the drive assembly is operable with the control unit.

10. The drive assembly of claim 1, wherein the input shaft is connected to a first power output.

11. A work machine, comprising:
a drive assembly including:
a transmission device having a first input side, a second input sides, and a first output side,
a dual-clutch transmission, wherein at least one gear is embodied as a winding path gear, and the dual-clutch transmission is connectable, or connected, to the first output side of the transmission device,
an input shaft,
an output shaft,
a drive unit connectable, or connected, to the input shaft,
a first energy machine connectable, or connected, to the input shaft,
a second energy machine connectable, or connected, to the transmission device,
wherein the drive unit is connectable, or connected, to the first or the second input side in such a way that a rotating speed or a direction of rotation of the first output side of the transmission device is settable, adjustable, or actuable.
